(19) United States
(12) Patent Application Publication
(10) Pub. No.: US 2016/0203392 A1
(43) Pub. Date: Jul. 14, 2016

(54) HYBRID DRAFT MODE PRINTING

(71) Applicant: Intel Corporation, Santa Clara, CA (US)

(72) Inventors: David Metcalfe, Webster, NY (US); Ryan Metcalfe, Webster, CA (US)

(21) Appl. No.: 14/593,132

(22) Filed: Jan. 9, 2015

(51) Int. Cl. G06K 15/02

(52) U.S. Cl. CPC G06K 15/1868

(57) ABSTRACT

Techniques related to hybrid draft mode printing are discussed. Such techniques may include rendering sections of a print job document for printing based on different render settings to provide a print ready document having low print quality areas and high print quality areas. Printing such documents for review, for example, may provide consumables savings, review improvement, and review cycle time reduction.

### BACKGROUND

Draft mode printing has gained acceptance as a standard multi-function device (MFD) feature that generally prints documents as fast as possible with minimal regard to print quality (PQ). For example, draft mode settings may be configured through the printer to minimize costs and elevate document throughput rates. Draft mode printing may, for example, be used after the copy job is generated via a scan-to-file option so that the user can quickly review and print one set of documents (e.g., prior to making multiple sets of copies) to ensure that the layout/format is what is expected/desired.

After the draft document and/or copy-job has been reviewed in draft mode by the user, multiple sets of copies may be printed under the MFD's standard, higher image-quality mode(s). Such techniques offer efficient, low-cost methods to examine a printed job without needlessly expending toner and/or ink consumables during the initial (and sometimes repeated) review process. Printing in draft mode, therefore, offers the advantages of saving ink or toner while at the same time allowing a cursory review of all documents contained within the copy job prior to printing the final (e.g., higher quality and multiple) set of copies.

However, in such draft mode printing techniques, there is an inherent generalization that all of the document's contents are equal from an image quality (IQ) standpoint and are therefore printed with the same lower print quality standards. Such lower IQ may cause difficulty in reviewing some portions of the document and/or in utilizing some portions of the document for other purposes. Such difficulty may cause less than desirable review results in draft mode, which may cause higher levels of consumable (e.g., ink or toner) usage as multiple review cycles are needed.

It is with respect to these and other considerations that the present improvements have been needed. Such improvements may become critical as the desire to save on printer consumables, decrease copy time in the review cycle, and/or to utilize lower image quality documents becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 illustrates an example print job document and an example print ready document;

FIG. 2 illustrates an example final print ready document;

FIG. 3 illustrates an example process for providing hybrid draft mode printing;

FIG. 4 is a block diagram illustrating an example device for providing hybrid draft mode printing;

FIG. 5 illustrates an example print job presentation;

FIG. 6 illustrates an example print job presentation;

FIG. 7 illustrates an example print job presentation;

FIG. 8 illustrates an example print job presentation;

FIG. 9 illustrates an example print job presentation;

FIG. 10 is a flow diagram illustrating an example process for providing draft mode printing;

FIG. 11 is an illustrative diagram of an example system for providing draft mode printing;

FIG. 12 is an illustrative diagram of an example system; and

FIG. 13 illustrates an example small form factor device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as multi-function devices, tablets, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to draft mode printing and, in particular, to providing a hybrid draft mode printing technique such that some objects or portions within a document may be printed with higher image quality (IQ) while surrounding objects, regions, or portions are printed with lower IQ.

As described above, in draft mode (e.g., also referred to as toner saving mode, economode, or earth smart mode in some contexts) printing techniques, a generalization may be made such that all of the contents of a document are equal from an image quality (IQ) standpoint and draft mode printing may be carried out with the same lower print quality standards for all regions, portions, or objects, or the like of the document. Such lower IQ for an entire document may cause, for certain objects or the like of some documents, difficulty in reviewing those objects in draft mode and/or in utilizing those objects of the document for other purposes. For example, printing a photograph or other image in draft mode may not allow a reviewer to fully evaluate the print quality of the image to properly predict the print quality in a subsequent final printing. Although the layout of the document may be evaluated and text and some graphics may be confidently predicted to be of high quality in the final printing, such photographs, some graphics, and other document elements may not be properly judged by printing using lower print quality standards.

For example, for a copy job that contains a mixed set of documents, objects, sections, portions, regions, or the like, there may be a strong desire to review a particular section or objects or the like within a document or documents within the copy job with a high IQ (e.g., the highest possible IQ or the IQ that will be used for the final print job or the like) while allowing the surrounding documents, objects, sections, portions, regions, or the like to retain print quality settings (e.g., and the associated lower costs and faster run times). As used herein, mixed documents, or mixed content or the like may refer to document(s) containing multiple types of content such as text content, line-art content, photographic content, or the like. As is discussed further herein, the described techniques may provide a hybrid draft mode method (e.g., an enhanced draft mode or an intermediary draft mode or the like) that may provide the ability to select higher IQ objects contained within a document (e.g., a scan-to-file copy job or the like) and may allow surrounding regions to be printed with the lower-cost settings. In some embodiments, such techniques may provide for more effective draft mode document review thereby eliminating wasteful review cycles. Furthermore, such techniques may, in other embodiments, provide documents having low image quality areas and high image quality areas. Such documents may be useful to users in some contexts. For example, a travel document printed using such techniques may include lower quality but readable print quality text regions (e.g., including traveler name and address and the like) and high quality print areas that may be needed for machine readable devices (e.g., linear barcodes or matrix barcodes or the like).

In some embodiments, hybrid draft mode printing may include receiving a print job document having at least a first section and a second section. The print job document may be of any suitable document type and, for example, the first section and the second section may be of different content types (e.g., the first section may be a photograph and the second section may include text). The print job may be received for printing at a particular print quality such as a low or draft mode print quality. Such a print quality may be used for an initial review of the print result from the print job document and may be suitable for evaluating the document layout and, for example, the second section (e.g., text section) of the print job document. However, such a print quality may not be suitable for evaluating the first section (e.g., a photograph). A print quality mode indicator associated with the first section may be received via an input device (e.g., from a user), based on a content analysis of the first section (e.g., the print quality mode indicator may be automatically generated), or from another source such as the print mode document itself. In any event, the print quality mode indicator may indicate a higher print quality mode for the first section of the document.

The first and second sections of the print job document (and any additional sections) may be rendered to generate a print ready document. For example, the first section may be rendered based on first render settings associated with the print quality mode indicator and the second section may be rendered based on second render settings associated with the print quality provided for the remainder of the print job document (e.g., default draft mode print settings or the like). The first render settings and the second render settings may have at least one difference such as differences in saturation, toner density, or contrast levels or the like. In some examples, the document may be printed and evaluated prior to printing the final, high-quality prints. Such techniques may provide for reduced consumable usage and faster print rates (e.g., by printing some sections of the document using lower quality settings) and more effective document review (by printing some sections using higher quality settings such that those areas may be properly evaluated). Such increase in review effectiveness may also reduce consumable usage and increase throughput time as review cycles are not wasted.

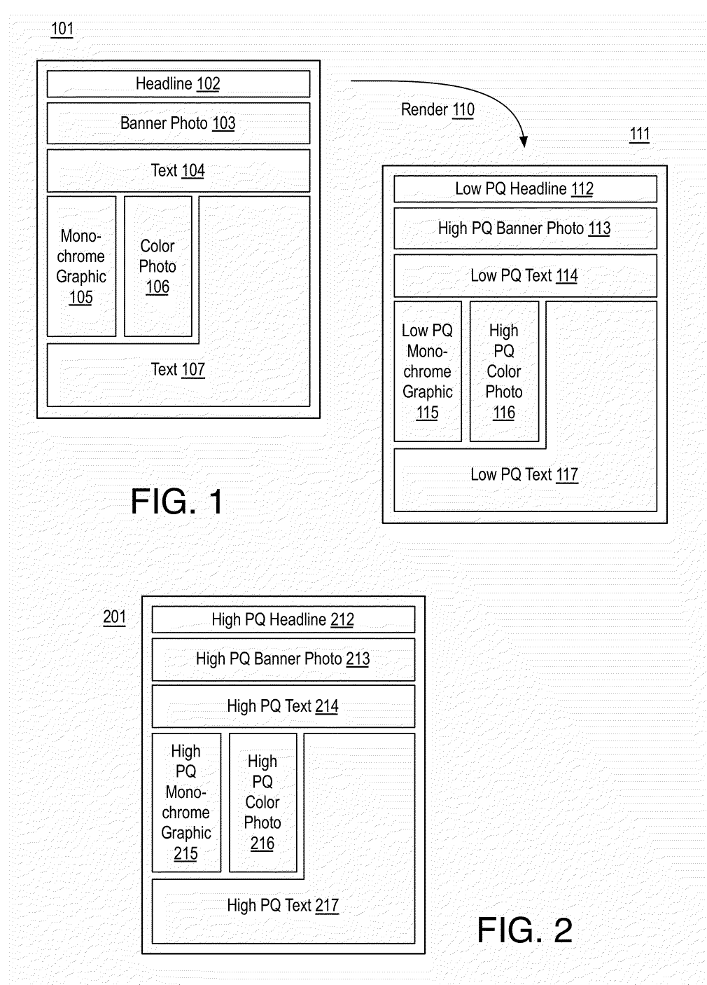

FIG. 1 illustrates an example print job document 101 and an example print ready document 111, arranged in accordance with at least some implementations of the present disclosure. As shown in FIG. 1, print job document 101 may include a variety of sections 102-107 such as headline section 102, banner photo section 103, text section 104, monochrome graphic section 105, color photo section 106 (all color sections and/or photographs illustrated herein are provided in grayscale for the sake of clarity of presentation), and text section 107. Print job document 101 may include any number and arrangement of sections. Furthermore, although illustrated as a single page for the sake of clarity of presentation, print job document 101 may include any number of pages. Print job document 101 may include any suitable electronic file type and may be stored in memory and/or presented to a user for manipulation. For example, print job document 101 may be a portable document format file, an image file, a word processing file, an image file, or the like. Print job document 101 may be attained using any suitable technique or techniques. For example, print job document 101 may be generated from a user, downloaded from a source, generated via a scan-to-file operation via a scanner device, or any combination thereof.

As discussed herein, it may be desirable to produce multiple high print quality copies of print job document 101. However, printing print job document 101 at high quality during a review phase may be overly costly, particularly when print job document 101 has many pages or when a large number of print job documents including print job document 101 are to be reviewed. Furthermore, it may be disadvantageous to print print job document 101 at low or lower quality because some sections of print job document 101 may not be suitably reviewed at low quality. In particular, with reference to print job document 101, the layout of sections 102-107 may be readily reviewed at a low print quality and certain sections such as headline section 102, text section 104, text section 107, and monochrome graphic section 105, however, other sections such as banner photo section 103 and color photo section 106 may not be readily reviewed at low quality since the low quality printing of photos may not provide the detail needed to ascertain whether an approvable high quality printing will take place. For example, such sections may need to be reviewed at high quality to ascertain whether the print result is acceptable.

In such examples, it may be advantageous to generate (e.g., via render operation 110) print ready document 111 having some sections 112-117 rendered for printing at low print quality (PQ) and some section rendered for printing at high PQ. Print ready document 111 may be any suitable file or data or the like that may be provided to a printer driver and/or a printer for printing. For example, sections rendered for high print quality may be rendered using a first set of render settings or print settings and sections rendered for low print quality may be rendered using a second set of render settings or print settings such that the first set generates higher print quality (e.g., higher saturation, toner density, or contrast or the like) than the second set. Although discussed herein with respect to high and low print quality settings, more than two print settings may be used such as low, medium, and high print quality settings or print settings with even more granularity. Furthermore, although discussed herein with respect to low, medium, and high print quality settings, other terms may be used. For example, medium or high print quality settings may be described as standard print settings and low print quality settings may be described as toner savings settings, economode settings, earth smart mode settings, or the like. Furthermore, the render or print settings may include any suitable settings that may provide for differentiation in eventual print quality such as saturation, contrast, resolution, toner density, brightness, or the like. For example, in low quality print modes, such settings may be suppressed to save consumables as discussed herein.

In the example of FIG. 1, sections suitable for low print quality review may be printed in low quality and sections unsuitable for low print quality review may be printed in high quality. For example, headline section 102 may be rendered to generate low PQ headline section 112, banner photo section 103 may be rendered to generate high PQ banner photo section 113, text section 104 may be rendered to generate low PQ text section 114, monochrome graphic section 105 may be rendered to generate low PQ monochrome graphic section 115, color photo section 106 may be rendered to generate high PQ color photo section 116, and text section 107 may be rendered to generate low PQ text section 117. As discussed, low PQ sections (e.g., sections 112, 114, 115, and 117) may be generated using different render settings (e.g., having at least one difference) than high PQ sections (e.g., sections 113, 116).

Print quality of sections 102-107 in print job document 101 may be provided using any suitable technique or techniques. In some examples, a draft of hybrid draft print mode may be selected such that all sections of print job document 101 are initially to be printed in low quality (e.g., a low or draft mode quality is the document printing default). High quality sections may then be provided by user selection (e.g., presenting print job document 101 and/or sections 102-107 to a user and allowing the user to select high quality sections or objects or the like), by automatically analyzing the content of sections 102-107 (e.g., to determine the content type of each section and providing high quality to certain content types such as photo or color photo types), by analyzing metadata associated with print job document 101 (e.g., to determine a content type of sections 102-107), or by receiving metadata or data tightly coupled to print job document 101 that indicates sections of print job document 101 that are to be printed in higher quality. For example, if print job document 101 is a receipt or flight document or the like, print job document 101 may indicate a barcode must or should (e.g., without some sort of user intervention) be printed in high quality.

Furthermore, as discussed herein, print ready document 111 may be provided to a printer or printer driver to generate a printed document. In some examples, the hybrid printed document may be reviewed. If changes are warranted, such changes may be made to print job document 101 and another version of print ready document 111 may be generated and reviewed and so on until an acceptable draft is generated. The techniques discussed herein may provide additional confidence that the draft (e.g., the hybrid draft) will generate a suitable high quality final print.

FIG. 2 illustrates an example final print ready document 201, arranged in accordance with at least some implementations of the present disclosure. As shown in FIG. 2, print ready document 201 may include sections 212-217, all of which are high print quality (PQ). For example, after review of a print generated from print ready document 111 has been approved, a final print ready document 201 may be generated including a high PQ headline section 212, a high PQ banner photo section 213, a high PQ text section 214, a high PQ monochrome graphic section 215, a high PQ color photo section 216, and a high PQ text section 217. For example, final print ready document 201 may be generated based on review and approval of a print based on print ready document 111 and final print ready document 201 may be provided to a printer and/or printer driver and printer for printing using high quality.

Such review cycles based on print job document 101 and print ready document 111 may provide reduced printing time, reduced consumable usage (e.g., less toner usage, less liquid-ink usage, less paper usage, or the like), and reduced review cycles as described herein.

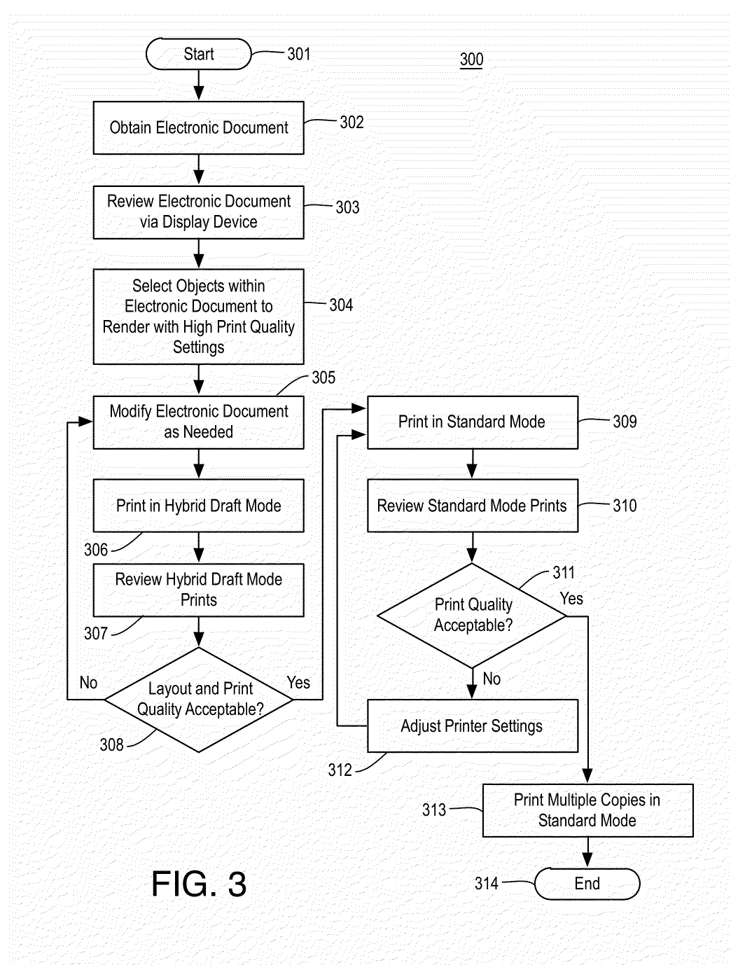

FIG. 3 illustrates an example process 300 for providing hybrid draft mode printing, arranged in accordance with at least some implementations of the present disclosure. Process 300 may include one or more operations 301-314 as illustrated in FIG. 3. Process 300 may be performed by a device (e.g., device 400 as discussed herein) or portions of process 300 may be performed by a device to provide hybrid draft mode printing and/or a review process based on hybrid draft mode printing. For example, process 300 may be performed to review a print job document using hybrid draft mode printing prior to printing at full or high print quality. Process 300 or portions thereof may be repeated for any number of print job documents.

As shown, process 300 may begin from start operation 301 at operation 302, “Obtain Electronic Document”, where an electronic document such as a print job document may be obtained. The print job document may be obtained using any suitable technique or techniques. For example, the print job document may be obtained from device memory, from an exterior source such as an external device, a network, a cloud, the Internet, or the like. In some examples, the print job document may be generated from a scan-to-file operation performed by a multifunction device (MFD). In some examples, the print job document may be locally generated by a user. The print job document may be any suitable format, file structure, or data structure. For example, the print job document may be a portable document format (PDF) file, an image file, a word processing file, or the like. The print job document may include any number of pages and/or any number of documents. In some examples, the print job document may be generated by scanning a set of documents using a scan-to-file feature of a multifunction device (either an integrated multifunction device or an external multifunction device). For example, the print job document may be received at a personal computer or other computing device from an MFD.

Processing may continue at operation 303, “Review Electronic Document via Display Device”, where the electronic document or print job document may be reviewed via a display device. For example, the print job document may be reviewed by a user via a display device of a personal computer or other computing device. In other examples, the print job document may be automatically reviewed by document review software to verify margins, page counts, section or object alignment, or the like.

Processing may continue at operation 304, “Select Objects within Electronic Document to Render with High Print Quality Settings”, where objects or sections within the electronic document or print job document may be selected for rendering with high print quality settings. For example, in process 300 it may be presumed that (or a user may select an option such that), at operation 306, default print settings (e.g., global print settings) may be low quality print settings such that sections for printing with high quality may be selected. In other examples, objects may be selected for printing with low quality such that the remaining portion (e.g., the unselected sections) may be printed with high print quality.

Objects or sections of the print job document may be selected at operation 304 using any suitable technique or techniques. In some examples, the print job document may be automatically segmented into regions, object, or sections and the print job document may be presented to a user via a display device such that the user may select the regions, object, or sections. The user may select such regions, object, or sections via any suitable technique or techniques such as pointing a mouse and clicking or tapping a touch-display or the like. In some examples, the print job document may not be previously segmented and a user may select regions, object, or sections by clicking and dragging a box around the regions, object, or sections, drawing a shape around the regions, object, or sections, or the like.

In some examples, regions, object, or sections may be selected without user intervention. For example, the print job document may be segmented to generate regions, object, or sections and the regions, object, or sections may be analyzed to determine the content thereof. A determination as to print in high quality may then be made based on the content type of the regions, object, or sections. In some examples, text content types, monochrome graphic content types, monochrome photo content types, and halftone content types may be printed in low quality. In some examples, photo content types (e.g., monochrome or color) may be printed in high quality. In some examples, color photo content types may be printed in high quality.

Processing may continue at operation 305, “Modify Electronic Document as Needed”, where the electronic document or print job document may be modified as needed. For example, the layout of the print job document may be modified, other editing tasks may be performed for the print job document, or the like. For example, the print job document may be edited and/or modified for printing at operation 305. For example, the editing and/or modifications may include deleting portions or pages of the print job document, reshuffling pages of the print job document, changing the orientation of objects in the print job document, or the like. For example, the print job document may be presented to a user via display device and edits may be received via one or more input devices (e.g., a mouse, a keyboard, a touch-screen, etc.).

Processing may continue at operation 306, “Print in Hybrid Draft Mode”, where the electronic document or print job document may be printed in hybrid draft mode. For example, the print job document may be rendered to generate a print ready document as discussed herein. For example, sections of the print job document may be rendered using the print settings or render settings set via operation 304 and the default print or render settings provided by the selected print feature. For example, a print ready document may be generated based on the print job document and the print or render settings associated with the regions, object, or sections of the print job document, and the print ready document may be provided to a printer driver and/or a printer for printing to generate a hard copy document. In some examples, the regions, object, or sections print or render settings may be implemented via properties or properties menus implemented via a printer driver. For example, the print ready document may be printed via a printer or a multifunction device or the like. In some example, only some pages of the print job document may be printed for review at operation 306.

Processing may continue at operation 307, “Review Hybrid Draft Mode Prints”, where the printed hybrid draft mode document may be reviewed. As discussed, the hybrid draft mode document may include sections printed in low quality and sections printed in high quality such that the hybrid draft mode document may provide faster printing and less consumable usage while providing a document having the elements and quality needed for effective review. The hybrid draft mode document may be reviewed using any suitable technique or techniques. For example, a user may review the hybrid draft mode document for proper pagination, layout accuracy, and, in particular in high quality print sections, the quality of print of the hybrid draft mode document.

Processing may continue at decision operation 308, “Layout and Print Quality Acceptable?”, where a determination may be made as to whether the layout and print quality of the hybrid draft mode document are acceptable. If not (e.g., changes are determined to be required based on hybrid draft mode document), processing may continue at operation 305 as discussed herein. In particular, operations 305-307 (and, if needed, operation 304) may be repeated as needed until the hybrid draft mode document is acceptable at operation 308. For example, such operations may be repeated based on the result of the hybrid draft mode document.

If the hybrid draft mode document is acceptable, processing may continue at operation 309, “Print in Standard Mode”, where the electronic document or print job document may be printed in standard or high quality mode. For example, based on the approval of the hybrid draft mode document, the print job may be provided at high quality. In some examples, the print job document may be rendered for printing based on high quality for all sections of the print job document to generate a final print ready document, which may be provided to a printer driver and/or a printer to generate a hard copy of the final print ready document. For example, the print job document may be rendered for printing and sent to a multifunction device with the highs cost/quality render or print settings (e.g., standard-mode settings). Such print or render settings may be implemented via properties or a properties menu implemented via a printer driver for example.

Processing may continue at operation 310, “Review Standard Mode Prints”, where the printed final document (e.g., standard or high quality printed document) may be reviewed. As discussed, the final document may include all sections printed high or standard quality. The final document may be reviewed using any suitable technique or techniques. For example, a user may review the final document for print quality and other document characteristics.

Processing may continue at decision operation 311, “Print Quality Acceptable?”, where a determination may be made as to whether the overall print quality and/or image quality of the printed final document is acceptable. If not (e.g., changes are determined to be required based on the printed final document), processing may continue at operation 312, “Adjust Printer Settings”, where printer settings may be adjusted. For example, multifunction device printer settings may be adjusted for higher print or image quality via properties or a properties menus implemented via a printer driver. Furthermore, processing may continue from operation 313 at operations 309-311 as discussed until a printed final document of acceptable print quality is generated.

If the printed final document is acceptable, processing may continue at operation 313, “Print Multiple Copies in Standard”, where multiple copies of the print job document may be printed. For example, based on the approval of the printed final document, the print job may be provided at high quality for as many copies as are needed to complete the print job. For example, the final multiple copies may be printed based on the print job document as modified at operation 305 using print or render settings determined at operation 309. As shown, process 300 may end at end operation 314.

The operations of process 300 may be repeated any number of times either in series or in parallel for any electronic documents or print job documents. As discussed, process 300 may save on time and cost in generating final printed documents and/or final printed document copies generated based on a print job document. In particular, the initial review phase (e.g., operations 302-308) may be particularly advantageous to lower print quality may be provided to save time and consumables and proper review of high quality print sensitive sections or objects. For example, as discussed, text sections may be good candidates for draft mode (or low print quality) rendering, since it may be safe to assume that default MFD settings (e.g., standard or high quality print settings) will render more than acceptable image quality (IQ). Similarly, monochrome pictures, monochrome halftone picture, and graphics generally provide predictable draft-to-standard print-mode rendering without the need for multiple review cycles. However, as discussed, color photographs may output different print IQ as a function of the scanner (if a scan-to-file operation is implemented) and the gamut of the printer. In such examples, it may be desirable to print such objects or sections in high or standard print quality as discussed herein.

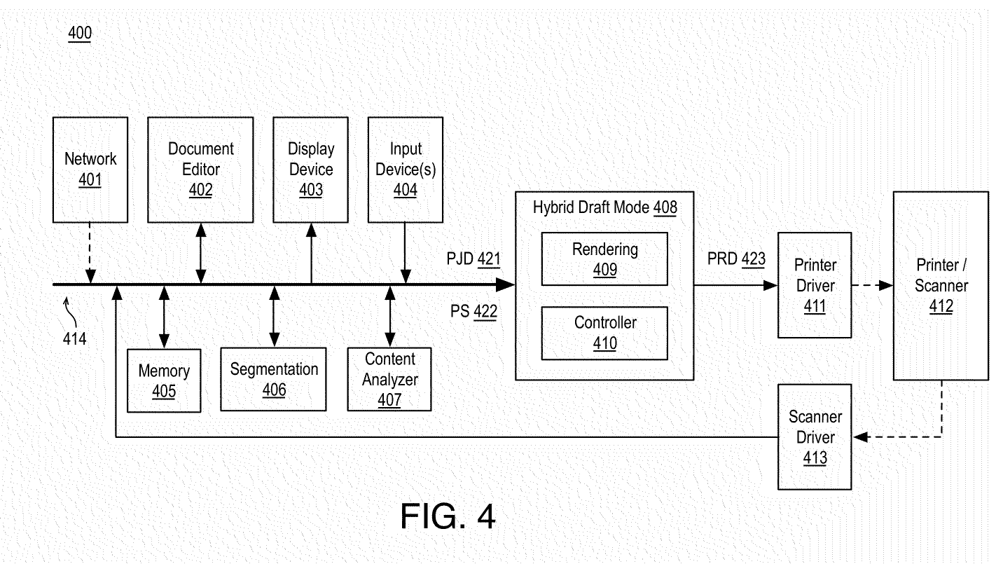

FIG. 4 is a block diagram illustrating an example device 400 for providing hybrid draft mode printing, arranged in accordance with at least some implementations of the present disclosure. As shown in FIG. 4, device 400 may include a document editor module 402, a display device 403, an input device 404, a memory 405, a segmentation module 406, a content analyzer 407, a hybrid draft mode module 408, a printer driver 411, and a scanner driver 413. Device 400 may also be connected to a printer/scanner 412 and an optional network 401. Also, as shown, hybrid draft mode module 408 may include a rendering module and a controller 410. Furthermore, various modules may be interconnected via a communications bus 414. Device 400 may be any suitable form factor device such as a computer, a laptop computer, a tablet, a smart phone, a multifunction device, a cut-sheet production printing press, or the like. In some examples, device 400 may be remote from and communicatively coupled to printer/scanner 412 (e.g., in computer, laptop computer, tablet, smart phone, etc. implementations). Such a communicative coupling may be formed via a wired coupling or a wireless coupling. In other examples, device 400 may include printer/scanner 412 (e.g., in multifunction device, cut-sheet production printing press, etc. implementations).

As shown, a print job document 421 may be provided to hybrid draft mode module 408. Print job document 421 may include any electronic or print job document as discussed herein in any suitable data or file format. Print job document 421 may be received, generated, or modified via any suitable module of device 400. For example, print job document 421 may be generated via printer/scanner 412 and/or scanner driver 413 via scan-to file operation. For example, an original document may be scanned via printer/scanner 412 and formatted via scanner driver 413 to generate print job document 421. In other examples, print job document 421 may be received via network 401, which may include any suitable communications network or channel or the like. For example, network 401 may be a local network, a cloud service, an Internet service, or the like. In some examples, print job document 421 may be retrieved from memory 405, which may be a local memory such as a device memory. In some examples, print job document 421 may be retrieved via a temporary memory source such as a universal serial bus (USB) memory device or the like.

Furthermore, print job document 421 may be presented to a user for viewing via display device 403 and print job document 421 may be edited, modified, or manipulated via input device 404. Display device 403 may be any suitable display such as a monitor or a built-in display device or the like. Similarly, input device 404 may be any suitable input device such as a keyboard, a mouse, or the like. In some examples, print job document 421 may be presented via display device 403, inputs may be received via input device 404, and modifications to print job document 421 may be made via document editor module 402.

As discussed herein, in some examples, sections or regions or the like of print job document 421 may be rendered for printing such that one or more sections are rendered for low print quality and one or more other sections are rendered for high print quality. In some examples, print settings 422 may indicate which sections are to be rendered for printing at which print quality settings. In some examples, a hybrid print mode may be selected by a user via document editor module 402. The hybrid print mode may automatically select as a default low quality printing for the entirety of print job document 421 and the user may select sections or regions of print job document 421 for printing with higher quality.

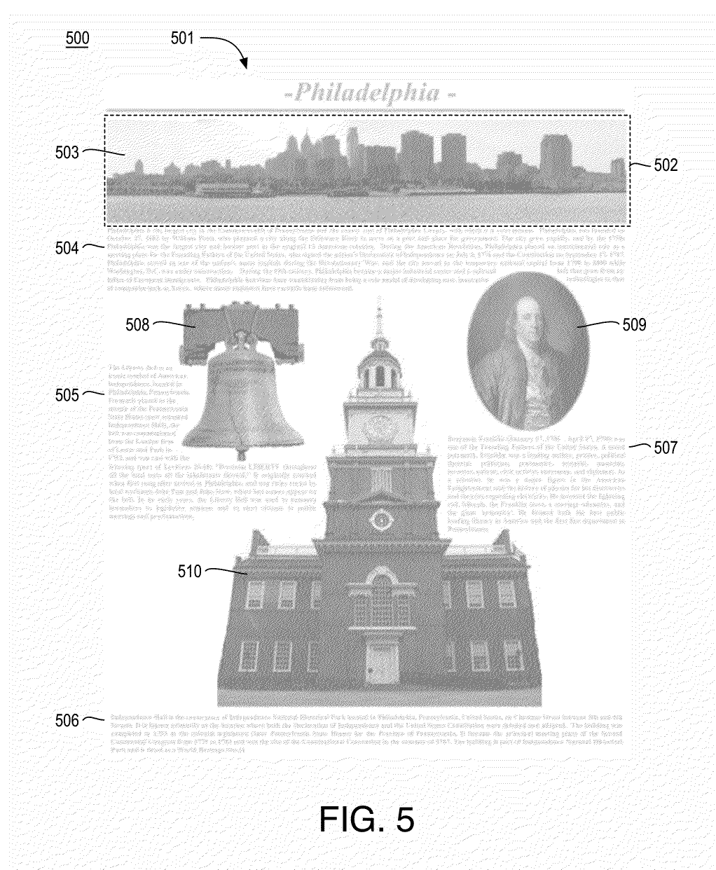

FIG. 5 illustrates an example print job presentation 500, arranged in accordance with at least some implementations of the present disclosure. As shown in FIG. 5, a print job document 501 may be presented to a user with a low quality print mode default. A user may then select objects or sections of print job document 501 for printing with a high quality print mode. Such selections may be associated with the regions and provided as a portion of print settings 422 (please refer to FIG. 4). In some examples, a high quality print mode selection may be made by the user providing a bounding box around a section or an object as shown with respect to bounding box 502 around a photo section 503. However, any suitable user selection technique may be used such as the user drawing a boundary around the section or object, selecting the section or object via a mouse or touch operation or the like.

For example, returning to FIG. 4, in some examples, print job document 421 or 501 may be segmented prior to presentation to a user. For example, print job document 421 or 501 may be analyzed to determine sections within print job document 421 or 501 using any suitable technique or techniques such as object or image recognition techniques, document analysis techniques, or the like. Returning to FIG. 5, in such examples, sections, such as text sections 504, 505, 506, 507 and photograph sections 508, 509, 510 may be recognized and provided as selectable segments, objects or sections of print job document 501. In such examples, an indicator or indicators may be provided to a user to indicate such sections are selectable. For example, bounding boxes may be provided around such sections or such sections may change to a high quality imaging when a user hovers a mouse indicator over the section. In other examples, a touch selection may highlight (e.g., via changing to high quality imaging or a bounding box appearing or the like) such sections.

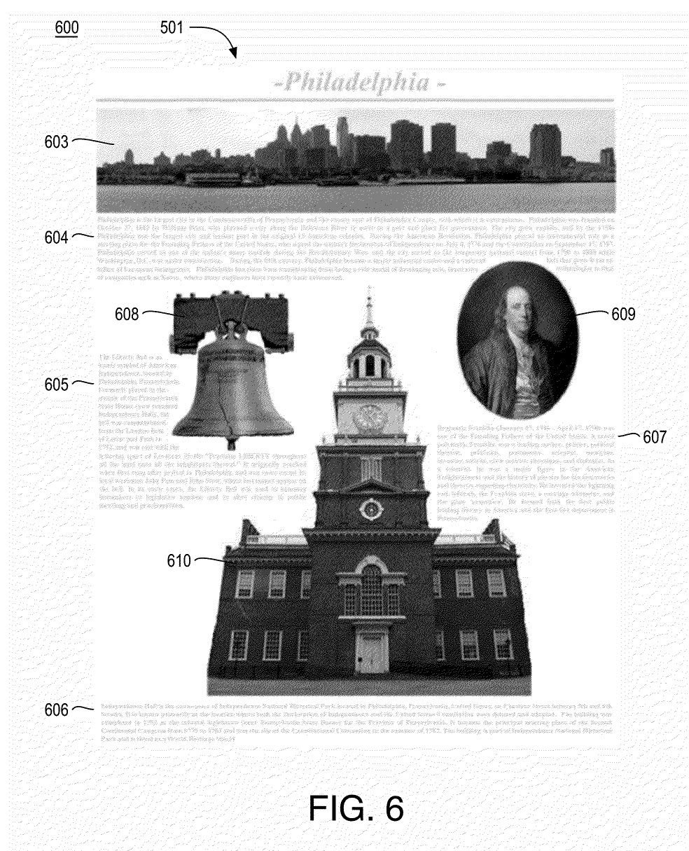

FIG. 6 illustrates an example print job presentation 600, arranged in accordance with at least some implementations of the present disclosure. For example, FIG. 6 may provide a presentation of print job presentation 600 after a user has selected photograph sections 603, 608, 609, 610 for printing via high quality print settings. Such selections may be made via bounding boxes, selection of predetermined segments of print job document 501 via touch selection or mouse pointing and clicking or the like. As shown, print job document 501 may include higher quality imaging of selected photograph sections 603, 608, 609, 610 and low or lower quality imaging of unselected text sections 604, 605, 606, 607. Such imaging may match the expected resulting print imaging for example.

Returning to FIG. 4, in other examples, print job document 421 may be segmented as discussed via segmentation module 406 into sections or objects or the like and such sections or objects may be analyzed via content analyzer 407 to provide content type indicators for some or all of the sections. For example, each section or object may be content analyzed to provide a content type indicator from one or more of a text type, a monochrome photo type, a halftone photo type a color photo type, a monochrome graphic type, or the like. Such types may be provided to hybrid draft mode module 408 or translated via content analyzer 407 to generate indicators of low or high print quality settings for the analyzed sections. For example, text type sections may be translated to low quality, color photo type may be translated to high quality, monochrome graphics type may be translated to low quality, and monochrome and/or monotone halftone photo types may be translated to high or low quality depending on predetermined settings or the like.

As discussed, print job document 421 and print settings 422 may be provided to hybrid draft mode module 408. Print settings 422 may include any indicators or other data indicating which sections of print job document 421 are to be printed in low quality and which are to be printed in high quality (or low, medium, high or the like depending on the implementation). Also as discussed, a default may be provided in such hybrid draft printing such that print job document 421 is received for printing via a low print quality mode and print settings 422 may include one or more print quality mode indicators indicating a section or sections of print job document 421 that may be printed in high print quality. For example, the print quality mode indicator(s) may be high print quality mode indicator(s) associated with one or more sections of a print job document. For example, returning to FIG. 6, print job document 501 may be provided for printing via a low print quality mode and high print quality mode indicators may be received for selected photograph sections 603, 608, 609, 610.

In other examples, the default for printing print job document 421 may be high quality and such print quality mode indicators may be low print quality mode indicators (or medium or low print quality indicators or the like). For example, continuing with FIG. 6, print job document 501 may be provide for printing via a high print quality mode and low print quality mode indicators may be received for selected text sections 604, 605, 606, 607. In yet other examples, print quality indicators may be received for each section of print job document 421 (e.g., without a default print quality) such that each section has a low or high (or low, med, high or the like) print quality indicator. Continuing with the example of FIG. 6, print job document 501 may be provide for printing with low print quality mode indicators for text sections 604, 605, 606, 607 and high print quality mode indicators for photograph sections 603, 608, 609, 610.

Returning to FIG. 4, print job document 421 may be rendered for printing via hybrid draft mode module 408 to generate a print ready document 423. For example, hybrid draft mode module 408 may include one or more rendering modules 409 that may render print job document 421 for printing under the control of controller 410. For example, rendering module 409 may render sections associated with low print quality (e.g., as indicated via print settings 422) using low print quality render settings and rendering module 409 may render sections associated with high print quality (e.g., as indicated via print settings 422) using high print quality render settings. In some examples, rendering module 409 (and any other rendering modules as provided in various implementations) may perform such rendering under the control of controller 410. For example, controller 410 may control high or low quality rendering based on print settings 422.

As shown, print ready document 423 may be provided to printer driver 411 and/or printer/scanner 412 for the generation of a hybrid draft document as discussed herein. In some examples, print ready document 423 may be provided to printer driver 411, which may generate data recognizable by printer/scanner 412 for the generation of a hard copy document. In other documents, hybrid draft mode module 408 may provide such printer driver functionality and print ready document 423 may be provided directly to printer/scanner 412 for printing of the hard copy document. Printer driver 411 and/or hybrid draft mode module 408 may communicate print ready document 423 via any suitable wired or wireless communications path.

As discussed herein, such a hard copy hybrid document having any number of pages may be evaluated for print acceptability (e.g., as discussed with respect to operation 308 of process 300). For example, if print job presentation 600 of FIG. 6 represents a single page of such a hard copy hybrid document, a user or automatic print job analyzer may evaluate print job presentation 600 for layout (e.g., the spatial relationship among sections 603-610) and print quality (e.g., particularly the print quality of high quality photograph sections 603, 608, 609, 610). As discussed, such hybrid printing may provide the opportunity to save consumables and time (as low quality sections are printed in low quality mode) while providing the opportunity to fully evaluate photographs and other printer dependent content. For example, operation 308 may provide for the opportunity to review not only document layout but also print quality in those sections that require print quality review. Furthermore, in regards to saving consumables and time, it warrants mentioning that the print job documents discussed herein may be many pages of text and/or other sections that may be evaluated on low quality and, in some contexts, sections needed to be printed at high quality may be relatively sparse. In such contexts, consumables and time savings may be substantial.

Also as discussed, such hybrid documents may be generated once for evaluation and, if acceptable, printing may proceed on a full standard (or high) quality print job. In other examples, such hybrid documents may be generated any number of times after layout edits or other edits until an acceptable document has been generated. In any event, a full standard (or high) quality print job may be generated based on the accepted hybrid document.

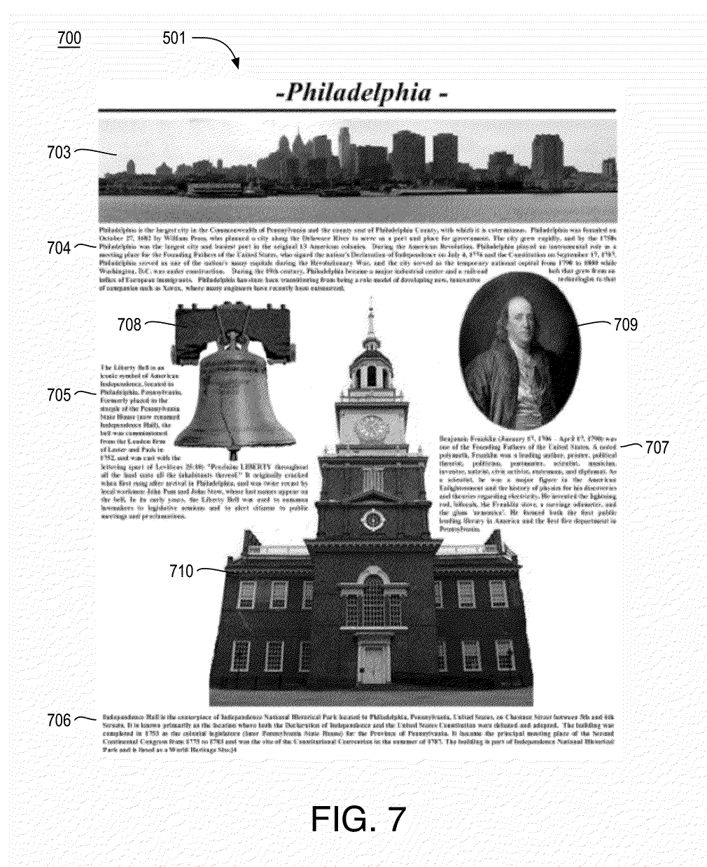

FIG. 7 illustrates an example print job presentation 700, arranged in accordance with at least some implementations of the present disclosure. For example, FIG. 7 provides a presentation of print job presentation 700 after acceptance of a hybrid print job such as print job presentation 600. As shown, all sections 703-710 of print job document 501 may be printed via high quality after evaluation of print job document via print job presentation 600. For example, all sections 703-710 of print job document 501 may be rendered, via rendering module 409 or another rendering module with high or standard print quality settings to generate a high quality print ready document, which may be printed via printer/scanner 412. As discussed, in some examples, a single full high quality print job may first be printed and evaluated and, once accepted, pint job document may be printed into multiple copies to finish the print job.

As discussed, in various examples, sections of a print job document may be user selected or automatically selected for high quality printing. In other examples, a print job document may include metadata or tightly coupled data to indicate a section or sections of the print job document are to be printed in high quality. For example, the techniques discussed herein may be used when a customer/consumer would like to reduce their overall printing costs to a minimum and may, therefore, render most (if not all) of their copies in a low quality or a low cost draft mode. However, barcodes contained in airline boarding passes, theater tickets, shopping receipts for store pick-up print outs, or they like may not be scanned accurately by barcode scanners when rendered in a low quality printing mode. In such examples, it may be advantageous to print a majority of the print job document with low quality but an important information section or sections with high quality. Such important information sections may be user selected or automatically detected as discussed herein or such important information sections may be pre-identified (e.g., pre-tagged) prior to the user receiving them (e.g., prior to download or the like) via metadata associated with the print job document or data tightly coupled with the print job document or the like.

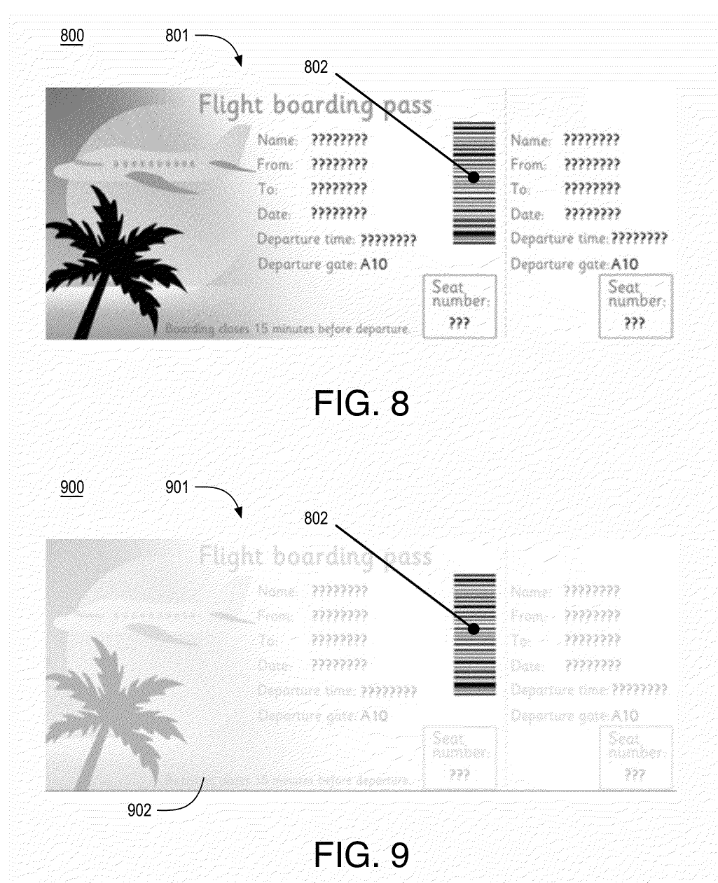

FIG. 8 illustrates an example print job presentation 800, arranged in accordance with at least some implementations of the present disclosure. For example, print job presentation 800 may include a print job document 801 such as a receipt or a boarding pass or the like. In some examples, a user or a system may select print job document 801 for printing via low quality mode or a draft mode or the like. However, in printing print job document 801 using such a low quality or a draft mode, important information may be lost such as information associated with important information section 802 (e.g., a linear barcode in the example of FIG. 8). For example, if print job document 801 were printed in a low quality or a draft mode, important information section 802 may be unreadable when produced and provided to a linear barcode scanner (e.g., when attempting to make a product return or at boarding or the like). Although illustrated with respect to a linear barcode, important information section 802 may include any suitable printing content such as a matrix barcode, an individual's photograph, an image including a watermark, important text (e.g., a name, account number, or price or the like), or any other suitable content.

FIG. 9 illustrates an example print job presentation 900, arranged in accordance with at least some implementations of the present disclosure. For example, print job presentation 900 may include a print job document 901 associated with print job document 801. For example, as discussed, print job document 901 may be a receipt or a boarding pass or the like. As shown, in some examples, important information section 802 of print job documents 901 may be provided for printing in a high quality mode while a background section 902 (e.g., other sections) may be provided for printing in a low quality mode. In some examples, important information section 802 may be provided for high quality printing as discussed herein (e.g., user selection or automatic content analysis or the like). In other examples, print job document 801 and/or 901 may include metadata or data tightly coupled to print job document 801 and/or 901 or the like indicating important information section 802. For example, the metadata or data tightly coupled to print job document 801 and/or 901 may indicate one or more sections that are to be printed in high quality mode even when print job document 801 and/or 901 are to be printed in a low quality or draft mode or the like. The metadata or data tightly coupled to print job document 801 and/or 901 may include any suitable information or data such as print settings or the like. In some examples, print job document 801 may be selected for printing by a user or automatically selected for printing by a device such as device 400. Print job document 801 may have metadata associated therewith and or/data tightly coupled therewith indicating important information section 802 must or should be printed using a high quality print setting even if print job document 801 is selected for printing via a low quality or draft mode printing mode or the like.

Referring to FIG. 4, hybrid draft mode module 408 may receive print job document 801 and print settings associated with print job document 801. For example, the print settings may indicate print job document 801 is being received for printing via a low quality mode, a draft mode, or a hybrid draft mode, or the like. Furthermore, print job document 801 and/or print settings 422 may include the discussed metadata and/or tightly coupled data to indicate important information section 802 is to be printed with high quality settings. Rendering module 409 may render important information section 802 using high quality print or render settings and background section 902 (or other one or more other sections of the print job document) using low quality print or render settings to generate a print ready document, which may be printed via printer driver 411 and/or printer/scanner 412.

Such printing techniques may preserve important information section 802 while reducing consumables and time in printing print job document 901. Furthermore, users may become accustomed to printing in draft mode or economode or the like and lower print quality may become acceptable to the user for many implementations (e.g., in printing web receipts or the like for recordkeeping). The described techniques may provide for high quality printing of important information even as users print the remainder of documents in a low cost low quality manner.

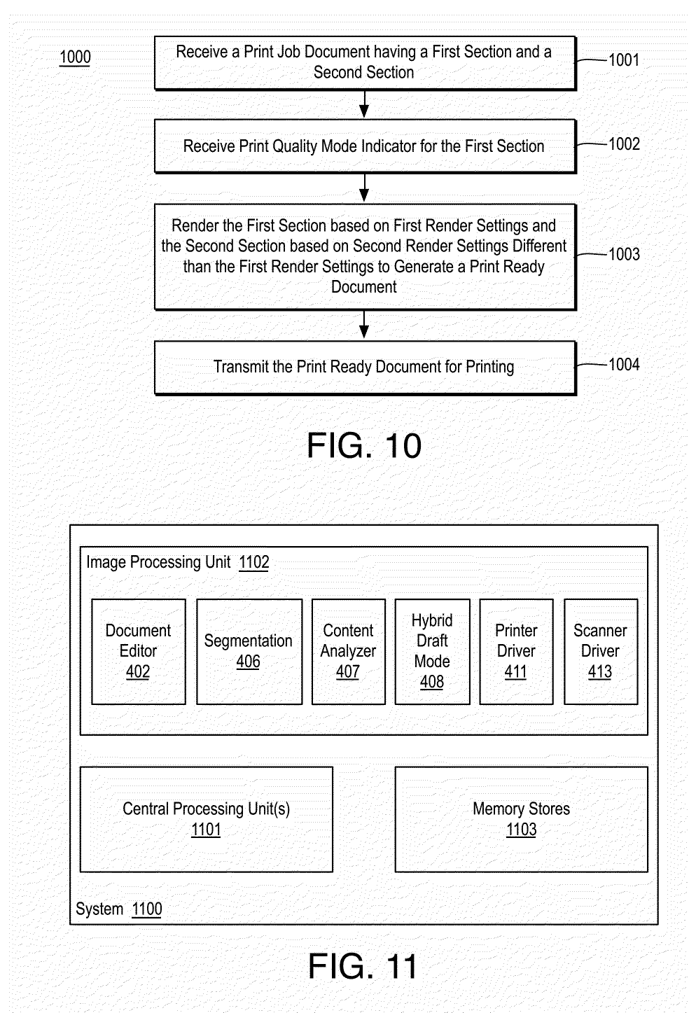

FIG. 10 is a flow diagram illustrating an example process 1000 for providing hybrid draft printing, arranged in accordance with at least some implementations of the present disclosure. Process 1000 may include one or more operations 1001-1004 as illustrated in FIG. 10. Process 1000 may form at least part of a hybrid draft mode process. By way of non-limiting example, process 1000 may form at least part of a hybrid draft mode printing process performed by device 400 as discussed herein. Furthermore, process 1000 will be described herein with reference to system 1100 of FIG. 11.

FIG. 11 is an illustrative diagram of an example system 1100 for providing draft mode printing, arranged in accordance with at least some implementations of the present disclosure. As shown in FIG. 11, system 1100 may include one or more central processing units (CPU) 1101, an image processing unit 1102, and memory stores 1103. Also as shown, image processing unit 1102 may include document editor module 402, segmentation module 406, content analyzer 407, hybrid draft mode module 408, printer driver 411, and/or scanner driver 413. Such modules may be implemented to perform operations as discussed herein. In the example of system 1100, memory stores 1103 may store print job data or other associated data such as print job documents, print ready documents, electronic documents, printer settings, render settings, document section indicators, print quality indicators associated with document sections, important information section data, metadata, tightly coupled data, input data, display data, content analysis data, document segmentation data, or the like.

As shown, in some examples, document editor module 402, segmentation module 406, content analyzer 407, hybrid draft mode module 408, printer driver 411, and/or scanner driver 413 may be implemented via image processing unit 1102. In other examples, one or more or portions of document editor module 402, segmentation module 406, content analyzer 407, hybrid draft mode module 408, printer driver 411, and/or scanner driver 413 may be implemented via central processing units 1101 or a graphics processing unit (not shown) of system 1100. In yet other examples, one or more or portions of document editor module 402, segmentation module 406, content analyzer 407, hybrid draft mode module 408, printer driver 411, and/or scanner driver 413 may be implemented via an imaging processing pipeline, printing pipeline, print engine, or the like.

Image processing unit 1102 may include any number and type of graphics processing units, image processing units, image signal processors, or the like that may provide the operations as discussed herein. Such operations may be implemented via software or hardware or a combination thereof. For example, image processing unit 1102 may include circuitry dedicated to manipulate image data obtained from memory stores 1103 (e.g., print job documents or the like). Central processing units 1101 may include any number and type of processing units or modules that may provide control and other high level functions for system 1100 and/or provide any operations as discussed herein. Memory stores 1103 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1103 may be implemented by cache memory. In an embodiment, one or more or portions of document editor module 402, segmentation module 406, content analyzer 407, hybrid draft mode module 408, printer driver 411, and/or scanner driver 413 may be implemented via an execution unit (EU) of image processing unit 1102. The EU may include, for example, programmable logic or circuitry such as a logic core or cores that may provide a wide array of programmable logic functions. In an embodiment, one or more or portions of document editor module 402, segmentation module 406, content analyzer 407, hybrid draft mode module 408, printer driver 411, and/or scanner driver 413 may be implemented via dedicated hardware such as fixed function circuitry or the like. Fixed function circuitry may include dedicated logic or circuitry and may provide a set of fixed function entry points that may map to the dedicated logic for a fixed purpose or function. In some embodiments, one or more or portions of document editor module 402, segmentation module 406, content analyzer 407, hybrid draft mode module 408, printer driver 411, and/or scanner driver 413 may be implemented via an application specific integrated circuit (ASIC). The ASIC may include an integrated circuitry customized to perform the operations discussed herein.

Returning to discussion of FIG. 10, process 1000 may begin at operation 1001, “Receive a Print Job Document having a First Section and a Second Section”, where a print job document having at least a first section and a second section may be received. For example, the print job document may be received via a network connection, a memory, or a multifunction device via scan-to-file operation or the like. For example, memory stores 1103 of system 1100 may receive a print job documents such as any print job document discussed herein. The print job document may include a first section and a second section or any number of sections as discussed herein. In some examples, the print job document may be generated via a scan-to-file operation executed via a scanner.

Processing may continue at operation 1002, “Receive Print Quality Mode Indicator for the First Section”, where a print quality mode indicator associated with the first section of the print job document may be received. In some examples, the print quality mode indicator may be received via hybrid draft mode module 408. For example, the print job document may be received for printing via a low print quality mode and the print quality mode indicator may include a high print quality mode indicator indicating the first section is to be rendered for printing using high print quality. The print job document may include any number of pages from a single page (e.g., such that the first and second sections are on the single page) to hundreds or thousands of pages. For example, the print job document may be large and complex and the print job itself may be for large number of copies.

The print quality mode indicator for the first section of the print job document may be generated or received using any suitable technique or techniques. In some examples, the print job document may be presented via a display device (e.g., to a user via display device 403) the print quality mode indicator may be received via an input device (e.g., via input device 404 based on input from the user). In other examples, the print job document may be automatically segmented (e.g., via segmentation module 406) into sections including the first section and the second section. The print job document with segmentation indicators may be presented via a display device (e.g., display device 403) such that the user may interact with the print job document and the print quality mode indicator may be received via an input device (e.g., via input device 404 based on input from the user). In yet other examples, the print job document may be automatically segmented (e.g., via segmentation module 406) into sections including the first section and the second section and the sections may be content analyzed (e.g., via content analyzer 407) to determine content types of the sections. The print quality mode indicator may then be generated based on the content type of the first section (and/or other sections of the print job document). In still further examples, the print quality mode indicator associated with the first section may be metadata associated with the print job document or data tightly coupled to the print job document. For example, such metadata or tightly coupled data may be received with the print job document.

Processing may continue at operation 1003, “Render the First Section based on First Render Settings and the Second Section based on Second Render Settings Different than the First Render Settings to Generate a Print Ready Document”, where the first section of the document may be rendered for printing based on first render settings associated with the print quality mode indicator and the second section of the document may be rendered for printing based on second render settings to generate a print ready document such that the first and second render settings comprise at least one difference. For example, the print job document may be received for printing via a low print quality mode and the print quality mode indicator may include a high print quality mode indicator. In such examples, the first render settings may provide higher print quality than the second render settings. Furthermore, in such examples, the content type of the first section of the print job document may be at least one of a color photograph content type or a barcode content type as discussed herein. In other examples, the print job document may be received for printing via a standard print quality mode, the print quality mode indicator may include a low print quality mode indicator, and the first render settings provide lower print quality than the second render settings.

Processing may continue at operation 1004, “Transmit the Print Ready Document for Printing”, where the print ready document may be transmitted for printing. For example, the print ready document may be transmitted to printer driver 411 or a remote printer for printing. As discussed the hybrid print mode hard copy document may be evaluated for proper layout and print quality. If the hybrid print mode hard copy document passes such an evaluation, a standard or high quality full document may be printed. For examples, the print job document may be rendered for printing based on third render settings to generate a final print ready document such that the third render settings provide higher print quality than at least one of the first or second render settings. For example, the third render settings may be high quality or standard print quality settings.

Such a process may provide hybrid draft printing. The output hard document may include any number of high quality sections and any number of low quality sections over any number of pages. The output hard document may be useful for document review and/or for usage as a final print document as discussed herein. Process 1000 may be repeated any number of times either in series or in parallel for any number of print job documents.

Various components of the systems described herein may be implemented in software, firmware, and/or hardware and/or any combination thereof. For example, various components of device 400, system 1100, system 1200, or device 1300 may be provided, at least in part, by hardware of a computing System-on-a-Chip (SoC) such as may be found in a multi-function device or a cut-sheet production printing press or a computing system such as, for example, a computer, a laptop computer, a tablet, or a smart phone. For example, such components or modules may be implemented via a multi-core SoC processor. Those skilled in the art may recognize that systems described herein may include additional components that have not been depicted in the corresponding figures.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of device 400, system 1100, system 1200, or device 1300, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

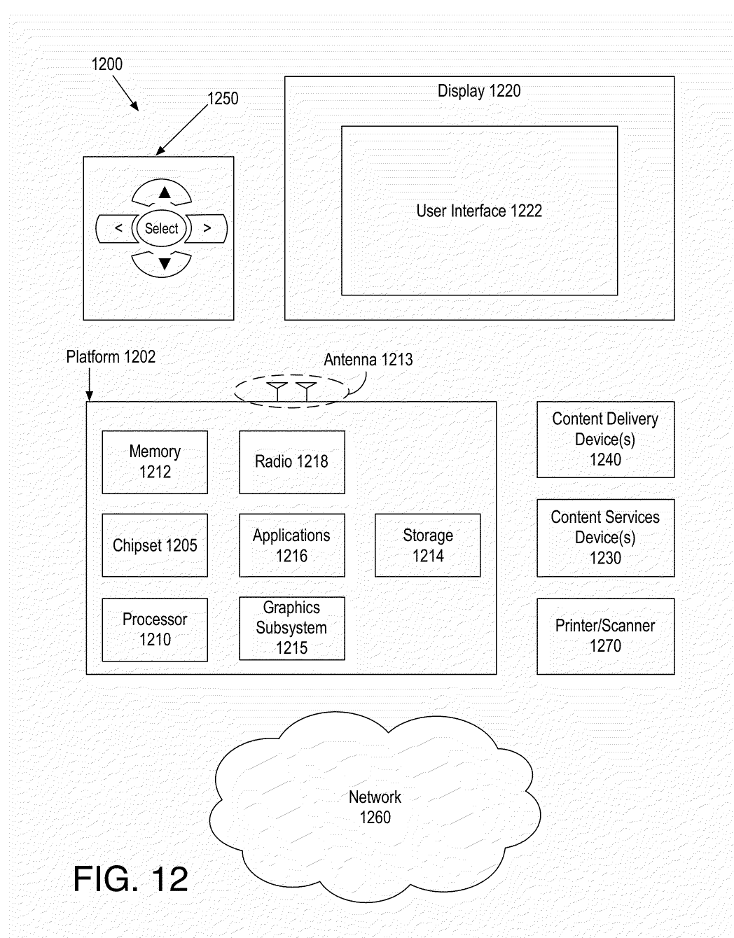

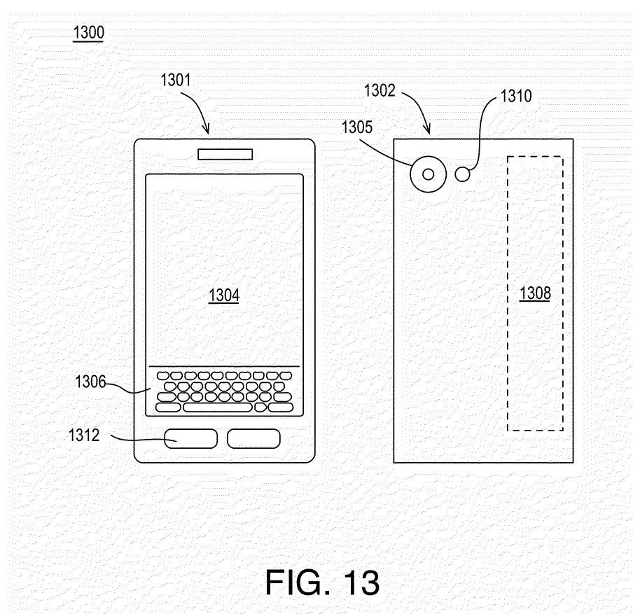

FIG. 12 is an illustrative diagram of an example system 1200, arranged in accordance with at least some implementations of the present disclosure. In various implementations, system 1200 may be a computing system although system 1200 is not limited to this context. For example, system 1200 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, peripheral device, scanner, printer, multi-function device, and so forth.

In various implementations, system 1200 includes a platform 1202 coupled to a display 1220. Platform 1202 may receive content from a content device such as content services device(s) 1230 or content delivery device(s) 1240 or other similar content sources such as a printer/scanner 1270. For example, platform 1202 may receive a scanned document from printer/scanner 1270 s a print job document. A navigation controller 1250 including one or more navigation features may be used to interact with, for example, platform 1202 and/or display 1220. Each of these components is described in greater detail below.

In various implementations, platform 1202 may include any combination of a chipset 1205, processor 1210, memory 1212, antenna 1213, storage 1214, graphics subsystem 1215, applications 1216 and/or radio 1218. Chipset 1205 may provide intercommunication among processor 1210, memory 1212, storage 1214, graphics subsystem 1215, applications 1216 and/or radio 1218. For example, chipset 1205 may include a storage adapter (not depicted) capable of providing intercommunication with storage 1214.

Processor 1210 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1210 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1214 may include technology to increase the storage performance enhanced protection for valuable digital media when multiple hard drives are included, for example.

Graphics subsystem 1215 may perform processing of images such as still images, graphics, or video for display. Graphics subsystem 1215 may be a graphics processing unit (GPU), a visual processing unit (VPU), or an image processing unit, for example. In some examples, graphics subsystem 1215 may perform scanned image rendering as discussed herein. An analog or digital interface may be used to communicatively couple graphics subsystem 1215 and display 1220. For example, the interface may be any of a High-Definition Multimedia Interface, DisplayPort, wireless HDMI, and/or wireless HD compliant techniques. Graphics subsystem 1215 may be integrated into processor 1210 or chipset 1205. In some implementations, graphics subsystem 1215 may be a stand-alone device communicatively coupled to chipset 1205.

The image processing techniques described herein may be implemented in various hardware architectures. For example, image processing functionality may be integrated within a chipset. Alternatively, a discrete graphics and/or image processor and/or application specific integrated circuit may be used. As still another implementation, the image processing may be provided by a general purpose processor, including a multi-core processor. In further embodiments, the functions may be implemented in a consumer electronics device.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1218 may operate in accordance with one or more applicable standards in any version.

In various implementations, display 1220 may include any flat panel monitor or display. Display 1220 may include, for example, a computer display screen, touch screen display, video monitor, television-like device, and/or a television. Display 1220 may be digital and/or analog. In various implementations, display 1220 may be a holographic display. Also, display 1220 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220. Platform 1202 and/or content services device(s) 1230 may be coupled to a network 1260 to communicate (e.g., send and/or receive) media information to and from network 1260. Content delivery device(s) 1240 also may be coupled to platform 1202 and/or to display 1220.

In various implementations, content services device(s) 1230 may include a cable television box, personal computer, network, telephone, Internet enabled devices or appliance capable of delivering digital information and/or content, and any other similar device capable of uni-directionally or bi-directionally communicating content between content providers and platform 1202 and/display 1220, via network 1260 or directly. It will be appreciated that the content may be communicated uni-directionally and/or bi-directionally to and from any one of the components in system 1200 and a content provider via network 1260. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

Printer/scanner 1270 may include any suitable peripheral device that may provide print and/or scan functionality. For example, printer/scanner 1270 may include a color inkjet or laser printer. In some examples, printer/scanner 1270 may include a flatbed or drum scanner or the like. In an example, printer/scanner 1270 may be implemented as a multi-function scan, print, fax device, or the like.

In various implementations, platform 1202 may receive control signals from navigation controller 1250 having one or more navigation features. The navigation features of navigation controller 1250 may be used to interact with user interface 1222, for example. In various embodiments, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1250 may be replicated on a display (e.g., display 1220) by movements of a pointer, cursor, focus ring, or other visual indicators displayed on the display. For example, under the control of software applications 1216, the navigation features located on navigation controller 1250 may be mapped to virtual navigation features displayed on user interface 1222, for example. In various embodiments, navigation controller 1250 may not be a separate component but may be integrated into platform 1202 and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example. Program logic may allow platform 1202 to stream content to media adaptors or other content services device(s) 1230 or content delivery device(s) 1240 even when the platform is turned “off.” In addition, chipset 1205 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1200 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various embodiments, platform 1202 and display 1220 may be an integrated unit. Display 1220 and content service device(s) 1230 may be integrated, or display 1220 and content delivery device(s) 1240 may be integrated, for example. These examples are not meant to limit the present disclosure.

In various embodiments, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 12.

As described above, system 1200 may be embodied in varying physical styles or form factors. FIG. 13 illustrates an example small form factor device 1300, arranged in accordance with at least some implementations of the present disclosure. In some examples, system 1200 may be implemented via device 1300. In other examples, device 400, system 1100, system 1200, or portions thereof may be implemented via device 1300. In various embodiments, for example, device 1300 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 13, device 1300 may include a housing with a front 1301 and a back 1302. Device 1300 includes a display 1304, an input/output (I/O) device 1306, and an integrated antenna 1308. Device 1300 also may include navigation features 1312. I/O device 1306 may include any suitable I/O device for entering information into a mobile computing device. Examples for I/O device 1306 may include an alphanumeric keyboard, a numeric keypad, a touch pad, input keys, buttons, switches, microphones, speakers, voice recognition device and software, and so forth. Information also may be entered into device 1300 by way of microphone (not shown), or may be digitized by a voice recognition device. As shown, device 1300 may include a camera 1305 (e.g., including a lens, an aperture, and an imaging sensor) and a flash 1310 integrated into back 1302 (or elsewhere) of device 1300. In other examples, camera 1305 and flash 1310 may be integrated into front 1301 of device 1300 or both front and back cameras may be provided. Camera 1305 and flash 1310 may be components of a camera module to originate image data processed into streaming video that is output to display 1304 and/or communicated remotely from device 1300 via antenna 1308 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one or more first embodiments, a method for providing hybrid draft mode printing comprises receiving a print job document having at least a first section and a second section, receiving a print quality mode indicator associated with the first section of the print job document, rendering at least the first section of the document based on first render settings associated with the print quality mode indicator and the second section of the document based on second render settings to generate a print ready document, wherein the first and second render settings comprise at least one difference, and transmitting the print ready document for printing.

Further to the first embodiments, the print job document is received for printing via a low print quality mode, the print quality mode indicator comprises a high print quality mode indicator, and the first render settings provide higher print quality than the second render settings.

Further to the first embodiments, the print job document is received for printing via a standard print quality mode, the print quality mode indicator comprises a low print quality mode indicator, and the first render settings provide lower print quality than the second render settings.

Further to the first embodiments, the print job document is received for printing via a low print quality mode, the print quality mode indicator comprises a high print quality mode indicator, and the first render settings provide higher print quality than the second render settings or the print job document is received for printing via a standard print quality mode, the print quality mode indicator comprises a low print quality mode indicator, and the first render settings provide lower print quality than the second render settings.

Further to the first embodiments, the method further comprises presenting the print job document via a display device, wherein the print quality mode indicator is received via an input device.

Further to the first embodiments, the method further comprises generating the print job document via a scan-to-file operation.

Further to the first embodiments, the method further comprises presenting the print job document via a display device, wherein the print quality mode indicator is received via an input device and/or generating the print job document via a scan-to-file operation.

Further to the first embodiments, the method further comprises automatically segmenting the print job document into the first section and the second section and presenting the print job document with segmentation indicators via a display device.

Further to the first embodiments, the method further comprises rendering the print job document based on third render settings to generate a final print ready document, wherein the third render settings provide higher print quality than at least one of the first or second render settings.

Further to the first embodiments, the print quality mode indicator associated with the first section comprises at least one of metadata associated with the print job document or data tightly coupled to the print job document.

Further to the first embodiments, the print job document is a single page document and the first and the second section are on the single page document.

Further to the first embodiments, the method further comprises automatically generating the print quality mode indicator based on a content type of the first section of the print job document.

Further to the first embodiments, the print job document is received for printing via a low print quality mode, the print quality mode indicator comprises a high print quality mode indicator, the first render settings provide higher print quality than the second render settings, and the content type of the first section of the print job document comprises at least one of a color photograph content type or a barcode content type.

In one or more second embodiments, a system for providing draft mode printing comprises a memory configured to receive a print job document comprising at least a first section and a second section and an image processing unit coupled to the memory, the image processing unit to render, based at least in part on a print quality mode indicator associated with the first section of the print job document, at least the first section of the document based on first render settings and the second section of the document based on second render settings to generate a print ready document, wherein the first and second render settings comprise at least one difference.

Further to the second embodiments, the print job document is associated with a low print quality mode, the print quality mode indicator comprises a high print quality mode indicator, and the first render settings provide higher print quality than the second render settings.

Further to the second embodiments, the print job document is associated with a standard print quality mode, the print quality mode indicator comprises a low print quality mode indicator, and the first render settings provide lower print quality than the second render settings.

Further to the second embodiments, the print job document is associated with a low print quality mode, the print quality mode indicator comprises a high print quality mode indicator, and the first render settings provide higher print quality than the second render settings or the print job document is associated with a standard print quality mode, the print quality mode indicator comprises a low print quality mode indicator, and the first render settings provide lower print quality than the second render settings.

Further to the second embodiments, the system further comprises a display device to present the print job document and an input device to provide the print quality mode indicator.

Further to the second embodiments, the system further comprises a scanner to generate the print job document via a scan-to-file operation.

Further to the second embodiments, the system further comprises segmentation logic to automatically segment the print job document into the first section and the second section and a display device to present the print job document with segmentation indicators.

Further to the second embodiments, the image processing unit is further to render the print job document based on third render settings to generate a final print ready document, wherein the third render settings provide higher print quality than at least one of the first or second render settings.

Further to the second embodiments, the print quality mode indicator associated with the first section comprises at least one of metadata associated with the print job document or data tightly coupled to the print job document.

Further to the second embodiments, the print job document is a single page document and the first and the second section are on the single page document.

Further to the second embodiments, the system further comprises content analyzer logic to automatically generate the print quality mode indicator based on a content type of the first section of the print job document.

Further to the second embodiments, the print job document is associated with a low print quality mode, the print quality mode indicator comprises a high print quality mode indicator, the first render settings provide higher print quality than the second render settings, and the content type of the first section of the print job document comprises at least one of a color photograph content type or a barcode content type.

Further to the second embodiments, the system comprises at least one of a computer, a laptop, a tablet, a smart phone, or a multifunction device.

In one or more third embodiments, a system for providing draft mode printing comprises means for receiving a print job document having at least a first section and a second section, means for receiving a print quality mode indicator associated with the first section of the print job document, means for rendering at least the first section of the document based on first render settings associated with the print quality mode indicator and the second section of the document based on second render settings to generate a print ready document, wherein the first and second render settings comprise at least one difference, and means for transmitting the print ready document for printing.

Further to the third embodiments, the print job document is received for printing via a low print quality mode, the print quality mode indicator comprises a high print quality mode indicator, and the first render settings provide higher print quality than the second render settings.

Further to the third embodiments, the print job document is received for printing via a standard print quality mode, the print quality mode indicator comprises a low print quality mode indicator, and the first render settings provide lower print quality than the second render settings.

Further to the third embodiments, the system further comprises means for presenting the print job document, wherein the print quality mode indicator is received via a means for receiving an input.

Further to the third embodiments, the system further comprises means for generating the print job document via a scan-to-file operation.

Further to the third embodiments, the system further comprises means for automatically segmenting the print job document into the first section and the second section and means for presenting the print job document with segmentation indicators.

Further to the third embodiments, the system further comprises means for rendering the print job document based on third render settings to generate a final print ready document, wherein the third render settings provide higher print quality than at least one of the first or second render settings.

Further to the third embodiments, the print quality mode indicator associated with the first section comprises at least one of metadata associated with the print job document or data tightly coupled to the print job document.

Further to the third embodiments, the print job document is a single page document and the first and the second section are on the single page document.

Further to the third embodiments, the system further comprises means for automatically generating the print quality mode indicator based on a content type of the first section of the print job document.

Further to the third embodiments, the print job document is received for printing via a low print quality mode, the print quality mode indicator comprises a high print quality mode indicator, the first render settings provide higher print quality than the second render settings, and the content type of the first section of the print job document comprises at least one of a color photograph content type or a barcode content type.

In one or more fourth embodiments, at least one machine readable medium comprises a plurality of instructions that, in response to being executed on a device, cause the device to provide hybrid draft mode printing by receiving a print job document having at least a first section and a second section, receiving a print quality mode indicator associated with the first section of the print job document, rendering at least the first section of the document based on first render settings associated with the print quality mode indicator and the second section of the document based on second render settings to generate a print ready document, wherein the first and second render settings comprise at least one difference, and transmitting the print ready document for printing.

Further to the fourth embodiments, the print job document is received for printing via a low print quality mode, the print quality mode indicator comprises a high print quality mode indicator, and the first render settings provide higher print quality than the second render settings.

Further to the fourth embodiments, the machine readable medium comprises further instructions that, in response to being executed on the device, cause the device to provide hybrid draft mode printing by presenting the print job document via a display device, wherein the print quality mode indicator is received via an input device.

Further to the fourth embodiments, the machine readable medium comprises further instructions that, in response to being executed on the device, cause the device to provide hybrid draft mode printing by automatically segmenting the print job document into the first section and the second section and presenting the print job document with segmentation indicators via a display device.

Further to the fourth embodiments, the print quality mode indicator associated with the first section comprises at least one of metadata associated with the print job document or data tightly coupled to the print job document.

Further to the fourth embodiments, the machine readable medium comprises further instructions that, in response to being executed on the device, cause the device to provide hybrid draft mode printing by automatically generating the print quality mode indicator based on a content type of the first section of the print job document.

In one or more fifth embodiments, at least one machine readable medium may include a plurality of instructions that in response to being executed on a computing device, causes the computing device to perform a method according to any one of the above embodiments.

In one or more sixth embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

1. A method for providing hybrid draft mode printing comprising:
receiving a print job document having at least a first section and a second section;
automatically segmenting the print job document into at least the first section and the second section;
presenting the print job document having the first section and the second section to a user via a display device;
receiving a print quality mode indicator associated with the first section of the print job document based on a user selection of the first section of the print job document received via an input device and based on the presentment of the print job via the display device;
rendering at least the first section of the print job document based on first render settings associated with the print quality mode indicator and the second section of the print job document based on second render settings to generate a print ready document, wherein the first and second render settings comprise at least one difference; and
transmitting the print ready document for printing.

2. The method of claim 1, wherein the print job document is received for printing via a low print quality mode, the print quality mode indicator comprises a high print quality mode indicator, and the first render settings provide higher print quality than the second render settings.

3. The method of claim 1, wherein the print job document is received for printing via a standard print quality mode, the print quality mode indicator comprises a low print quality mode indicator, and the first render settings provide lower print quality than the second render settings.

4. (canceled)

5. The method of claim 1, further comprising:
generating the print job document via a scan-to-file operation.

6. The method of claim 1, wherein presenting the print job document having the first section and the second section comprises presenting the print job document with segmentation indicators.

7. The method of claim 1, further comprising:
rendering the print job document based on third render settings to generate a final print ready document, wherein the third render settings provide higher print quality than at least one of the first or second render settings.

8. (canceled)

9. The method of claim 1, wherein the print job document is a single page document and the first and the second section are on the single page document.

10. The method of claim 1, further comprising:
automatically generating a second print quality mode indicator associated with a third section of the print job document based on a content type of the third section of the print job document.

11. The method of claim 1, wherein the print job document is received for printing via a low print quality mode, the print quality mode indicator comprises a high print quality mode indicator, the first render settings provide higher print quality than the second render settings, and the content type of the first section of the print job document comprises at least one of a color photograph content type or a barcode content type.

12. A system for providing draft mode printing comprising:
a memory configured to receive a print job document comprising at least a first section and a second section;
an image processing unit coupled to the memory, the image processing unit to automatically segment the print job document into at least the first section and the second section;
a display device to present the print job document having the first section and the second section to a user; and
an input device, the image processing unit further to receive a print quality mode indicator associated with the first section of the print job document based on a user selection of the first section of the print job document received via the input device and based on the presentment of the print job via the display device, to render, based at least in part on the print quality mode indicator associated with the first section of the print job document, at least the first section of the document based on first render settings and the second section of the document based on second render settings to generate a print ready document, wherein the first and second render settings comprise at least one difference, and to transmit the print ready document for printing.

13. The system of claim 12, wherein the print job document is associated with a low print quality mode, the print quality mode indicator comprises a high print quality mode indicator, and the first render settings provide higher print quality than the second render settings.

14. The system of claim 12, wherein the print job document is associated with a standard print quality mode, the print quality mode indicator comprises a low print quality mode indicator, and the first render settings provide lower print quality than the second render settings.

15-17. (canceled)

18. The system of claim 12, further comprising:
content analyzer logic to automatically generate a second print quality mode indicator based on a content type of a third section of the print job document.

19. The system of claim 12, wherein the system comprises at least one of a computer, a laptop, a tablet, a smart phone, or a multifunction device.

20. At least one non-transitory machine readable medium comprising a plurality of instructions that, in response to being executed on a device, cause the device to provide hybrid draft mode printing by:
receiving a print job document having at least a first section and a second section;
automatically segmenting the print job document into at least the first section and the second section;
presenting the print job document having the first section and the second section to a user via a display device;
receiving a print quality mode indicator associated with the first section of the print job document based on a user selection of the first section of the print job document received via an input device and based on the presentment of the print job via the display device;
rendering at least the first section of the print job document based on first render settings associated with the print quality mode indicator and the second section of the print job document based on second render settings to generate a print ready document, wherein the first and second render settings comprise at least one difference; and
transmitting the print ready document for printing.

21. The machine readable medium of claim 20, wherein the print job document is received for printing via a low print quality mode, the print quality mode indicator comprises a high print quality mode indicator, and the first render settings provide higher print quality than the second render settings.

22-24. (canceled)

25. The machine readable medium of claim 20, the machine readable medium comprising further instructions that, in response to being executed on the device, cause the device to provide hybrid draft mode printing by:
automatically generating a second print quality mode indicator associated with a third section of the print job document based on a content type of the third section of the print job document.

26. The machine readable medium of claim 20, wherein the print job document is received for printing via a standard print quality mode, the print quality mode indicator comprises a low print quality mode indicator, and the first render settings provide lower print quality than the second render settings.

27. The machine readable medium of claim 20, wherein presenting the print job document having the first section and the second section comprises presenting the print job document with segmentation indicators.

28. The machine readable medium of claim 20, the machine readable medium comprising further instructions that, in response to being executed on the device, cause the device to provide hybrid draft mode printing by:
rendering the print job document based on third render settings to generate a final print ready document, wherein the third render settings provide higher print quality than at least one of the first or second render settings.

29. The machine readable medium of claim 20, the machine readable medium comprising further instructions that, in response to being executed on the device, cause the device to provide hybrid draft mode printing by:
rendering at least a third section of the print job document based on third render settings associated with a second print quality mode indicator associated with the print job document, wherein the second print quality mode indicator comprises at least one of metadata associated with the print job document or data tightly coupled to the print job document.

30. The method of claim 1, wherein the first and second render settings comprise different saturations, toner densities, and contrasts.

31. The method of claim 1, further comprising:
rendering at least a third section of the print job document based on third render settings associated with a second print quality mode indicator associated with the print job document, wherein the second print quality mode indicator comprises at least one of metadata associated with the print job document or data tightly coupled to the print job document.

32. The system of claim 12, wherein the display device to present the print job document having the first section and the second section comprises the display device to present the print job with segmentation indicators.

33. The system of claim 12, wherein the image processing unit is to render at least a third section of the print job document based on third render settings associated with a second print quality mode indicator associated with the print job document, wherein the second print quality mode indicator comprises at least one of metadata associated with the print job document or data tightly coupled to the print job document.
